(19) United States
(12) Patent Application Publication
(10) Pub. No.: US 2003/0036922 A1
(43) Pub. Date: Feb. 20, 2003

(54) Method and system for examining real estate abstracts of title

(76) Inventor: John A. Fries, Moon Township, PA (US)

Correspondence Address: PEPPER HAMILTON LLP, ONE MELLON CENTER, 50TH FLOOR, 500 GRANT STREET, PITTSBURGH, PA, 15219, US

(21) Appl. No.: 10/219,835

(22) Filed: Aug. 15, 2002

Related U.S. Application Data
(60) Provisional application No. 60/312,439, filed on Aug. 15, 2001.

(51) Int. Cl. G06F 17/60

(52) U.S. Cl. 705/1; 705/35

(57) ABSTRACT

A method and system for automatically examining an abstract of title for a real estate maintains title data corresponding to the real estate parcel and accesses a database of title examination rules. The rules are applied to the title data to yield a title examination result for the real estate parcel. The result preferably includes a score, a list of applicable exceptions, and other considerations that are useful in generating title insurance commitments for the parcel.

### CLAIM OF PRIORITY

This application claims priority to U.S. provisional patent application No. 60/312,439, titled “Method and System for Examining Real Estate Abstracts of Title,” filed Aug. 15, 2001, which is incorporated herein by reference in its entirety.

### FIELD OF THE INVENTION

The present invention relates generally to methods and systems relating to real estate. More particularly, the present invention relates to a computer-implemented method and system for examining the title to a real estate parcel.

### BACKGROUND OF THE INVENTION

A routine step in preparing for the closing of a real estate transaction is a title search. The “title” to a property is a formal right of ownership of the property. In real estate contracts, such as those for a transfer of an interest in real estate, contracts relating to financing whereby the real estate serves as security for the financing, and real estate insurance contracts, it is commonly required that proof of title be provided in order to identify the correct owner or owners of interests in the property. The parties to the transaction typically hire a title insurance company, a title search agent, or an attorney to provide such proof.

To obtain proof of title, the insurance company, search agent, or attorney must search the recorded title-related documents for the property. Such a search is performed manually at a central location, typically at a local government repository such as the office of a recorder of deeds or a private “title plant”. The results of the search may show items such as the current owner of the property, record owners of easement or other access rights on, over or under the property, and holders of mortgage interests in the property.

When an insurer determines whether and how to prepare an insurance policy that insures title to the parcel of real estate, the insurer gathers data that results from the title search to make judgments about the insurability of the property. The judgments are made by humans, typically title examiners, who evaluate the condition of the title and determine whether, in their judgment, exceptions from title insurance coverage should be written into a title insurance policy and what requirements or conditions precedent need to be met.

The prior title examination procedures are time consuming, and the results can vary with the subjectivity of the particular title examiner who performs the examination. The search of recorded documents typically includes a search of all records of interests held during the past 40 to 60 years, or until a prior effective title insurance policy exists, or another sufficient beginning point. This search is performed with each examination, each time that an insurance policy is required.

If a method or system existed for the automated examination of real estate title, exception coverage could be established with a uniform set of rules, and thus it would be consistent from property to property. In addition, an automated, rule-based title examination system could perform the examination much more quickly than a human title examiner could do, and in a much more cost-effective manner.

The present invention is directed to an arrangement which solves one or more of the above noted problems.

### SUMMARY OF THE INVENTION

A preferred embodiment of the invention provides a method of examining title to a real estate parcel, including the step of maintaining a database containing parcel data corresponding to a real estate parcel. The parcel data preferably includes owner identifications and roles, legal descriptions and/or other identifications of the property, recorded interests, and/or governmental assessment and payment records. The preferred embodiment also includes the steps of maintaining a database containing rules for examining title to the real estate parcel, applying one or more of the rules to the parcel data to yield a title examination result or grade for the real estate parcel. It optionally and preferably also includes the step of generating a report comprising the title examination result. The report may also include a list of all rules that did not yield a satisfactory title examination result. Some or all of the above steps are performed by a computing apparatus, and the databases are maintained in a computer-readable memory.

Optionally and preferably, the applying step comprises examining the recorded ownership identifications for the parcel to determine whether, upon each transfer of the parcel from one owner to another owner, the recorded owner identification of a buyer for a first transfer matches the recorded owner identification of a seller for a next transfer. If they do not match, the applying step may also include analyzing the roles of the buyer for the first transfer and the seller for the next transfer. If the roles do not support a cure, the method may include requesting human intervention and/or generating a report indicating a break in the chain of title for the parcel.

Optionally and preferably, the applying step may include examining recorded liens, encumbrances and/or adverse interests for the parcel, determining whether one or more liens, encumbrances and/or adverse interests attach to the parcel. The title examination result will then preferably include a report of all recorded liens, encumbrances and/or adverse interests that have not been discharged for the parcel. The grade of the parcel may be reflective of the relative ability to extinguish the recorded liens, encumbrances and/or adverse interests. The applying step may also include examining recorded governmental assessments and recorded governmental payments relating to the parcel. The title examination result will then preferably include either a report of all recorded governmental assessments that have not been paid for the parcel, or an assertion that applicable assessments have been paid. The grade may also be reflective of whether the relevant parcel owner's name is determined to be a common name.

The method may also compare the parcel's current legal description to previously-recorded legal descriptions for the parcel to assess consistency of the current legal description with the previously-recorded legal descriptions. Further, it may maintain in a database containing validation keywords, analyze the legal description for the parcel to determine whether the legal description includes at least a predetermined number of the validation keywords, and base a determination of whether the legal description is valid on whether the legal description includes at least the predetermined number of the validation keywords.

Any or all of the above-described steps may be implemented on a computer system or other processing device, with the instructions residing in a computer-readable memory or carrier.

### BRIEF DESCRIPTION OF THE DRAWINGS

FIG. 1 is a flowchart providing an overview of a preferred embodiment of the present inventive process.

FIG. 2 is a flowchart illustrating an option where the specific rules selected may depend on whether the current property owner's name is determined to be a common name.

FIGS. 3 and 4 illustrate a first exemplary rules-based scoring method in according with the invention.

FIGS. 5 and 6 illustrate an alternate exemplary rules-based scoring method in according with the invention.

FIG. 7 illustrates a computer of a type suitable for carrying out and/or comprising the system of the invention.

FIG. 8 illustrates a block diagram of the internal hardware of the computer of FIG. 7.

### DETAILED DESCRIPTION OF PREFERRED EMBODIMENTS OF THE INVENTION

The present invention is directed to the automation of the abstract of title review process. In accordance with a preferred embodiment of the present invention, data corresponding to title abstract information for one or more parcels of real estate is entered into, or maintained by, a computer program memory, such as that contained within a server, personal computer, a laptop computer, a personal digital assistant or palm-type device, a smart disk, or even a communications device such as a cellular phone that is capable of communicating with a computing device. The data is preferably stored in one or more databases. The preferred data elements include one or more of the following fields:

owner name(s)

legal description

recording information for instruments that purport to convey an interest in the property (e.g., mortgage, will, deed, easement, etc.)

recording information for instruments that purport to encumber the property (e.g., judgments, liens, etc.)

government payment records (e.g., taxes, municipal/utility payments, etc.)

estates (i.e., transfers by operation of law)

When future title searches are performed for a parcel of real estate, the only information that is required to be entered into the database is the abstract information that post-dates the entries that are already in the database for the parcel. Abstract information that may be included in the database includes any information that could be obtained from a review of applicable documents in a chain of title. For example, the database may include grantor and/or grantee information, recording dates of deeds and other documents, recording references, and/or legal descriptions. Information relating to mortgages, such as mortgagee and mortgagor information, may also be included. If applicable, the database may also include information such as tax assessments, amounts, and payments, easements, restrictions, estate information, foreclosure information, and/or bankruptcy information.

Preferably, once data entry of title abstract information for a parcel has been completed, an event flag for that parcel will be set. The event flag will indicate that automated title examination for that parcel is available.

An additional database of title examination rules is also maintained in the memory of a computing device. These rules may be applied to the data elements corresponding to the abstract information for a parcel. They may, for example, check the state or condition of the data elements, compare one data element with another data element or elements, or determine whether a data element is acceptable for the purposes of the user. The rules may be tailored to the user's specifications, based on requirements such as the product for which the user is examining the abstract (i.e., a flood insurance product or a mortgage insurance product), the mortgage type, or specific rules required by an underwriter. The rules may also be tailored to the location of the parcel, and may reflect for example the parcel's state, county, or size. Thus, rules may be state-specific, county-specific, or even municipality-specific. The rules are directed to determining whether any potential problems exist with the title that would prevent the issuance, create exceptions, or require human intervention before the issuance, of insurance or a mortgage by the user. If the application of a rule to a data element results in a failure of the data element to satisfy the rule, the user is notified, either by an on-screen or audio notification, and further processing is halted until the user authorizes additional processing. Preferably, the rules correspond, at least in part, to a uniform set of published title examination standards, although the rules may be modified or customized to meet the needs of the individual user.

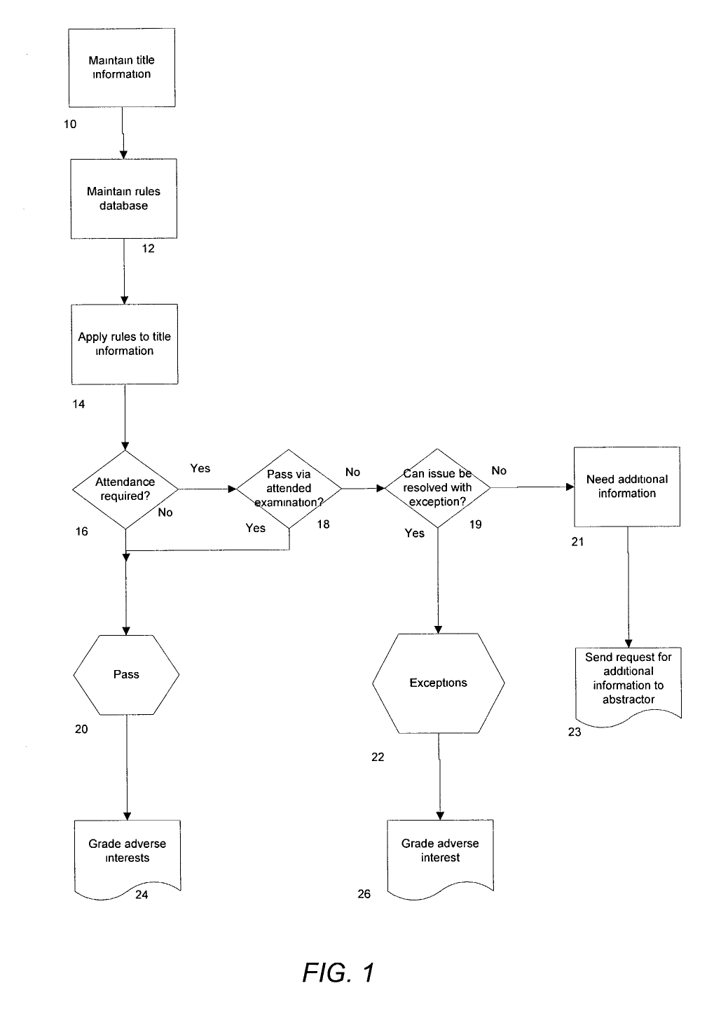

A flowchart providing an overview of a preferred embodiment of the automated title examination process is illustrated in FIG. 1. Referring to FIG. 1, title information, such as owner information, a legal description, recorded interests and encumbrances, taxes and other governmental assessments and payments, and/or transfers by estate, for a real estate parcel is maintained 10 in a computer memory, preferably in a database. The invention may also include entering the title information each time, or at any time, that title examination is required, but preferably the information is maintained in a database. A set of title examination rules is also maintained 12 in a computer program memory, preferably in database or table format. A computer processor receives and implements instructions to apply 14 one or more of the rules to the title information to generate a title examination result for the parcel. If the system determines, through application of the rules to the data, that there is an issue with the title (such as a break in the chain of ownership), the system may signal for human intervention 16 to investigate the reasons for the break. The human may then manually determine 18 whether to pass or fail the property's title examination. If human intervention or attendance is not required, the system may automatically pass 20 the property and issue a satisfactory title examination report. If human attendance is required, a determination is preferably made 19 of whether the issue may be resolved with one ore more exceptions identifying the specific areas of title that should be excluded from insurance coverage If so, the exceptions are reported 22 and a grade is preferably established 24. If additional information is needed 21, a request for additional information may be sent 23 to an abstractor. A title examination report preferably identifies the rules, if any, that resulted in the issue, and it also include a list of exceptions, such as adverse interests, liens, etc. In either case, the title is optionally and preferably graded 24 and 26, ranked, or otherwise scored to indicate the relative ease of extinguishing any adverse interests. As used herein, the terms “rank”, “grade”, and “score” are used synonymously to refer to any system of indicating a positive title examination result, negative title examination result, or some point in between.

In a preferred embodiment, the parcel data includes identifications of successive owners over a time period, such as 60 years or any time period for which examination is desired. As used herein, the term “owner” is intended to include any person or legal entity that owns or owned any interest in the relevant real estate parcel at any time. The data also preferably includes a role for each owner, such as an individual, corporation, executor, joint tenant, lessee, mortgagor, or other role that reflects the nature of the owner's interest in the property.

In the preferred embodiment described above, the rules preferably include examining the recorded ownership identifications to determine whether, upon each successive transfer of the parcel, the buyer in a first transfer matches the seller in the next transfer. If the successive buyer and seller do not match, the system may preliminarily determine that a break in the chain of title exists. Preferably, additional rules are applied to try to solve the issue before human intervention is required. For example, in a preferred embodiment each owner of an interest in the property is assigned a role. For example, if buyer having a role as an “individual” died during ownership of the property, the property may have passed through the estate to the buyer's heir. Thus, if a buyer has a role of “individual” while the next seller has the role of the buyer's “heir,” then no break in the chain of title occurred, and no human intervention would be required.

Preferably, the application 14 of the rules to the data also looks for additional issues, such as whether recorded liens, encumbrances, and/or adverse interests have been discharged, and which ones remain to be discharged. The application 14 of rules may also include a determination of governmental assessments and payments, as well as a comparison of legal descriptions in successive transactions.

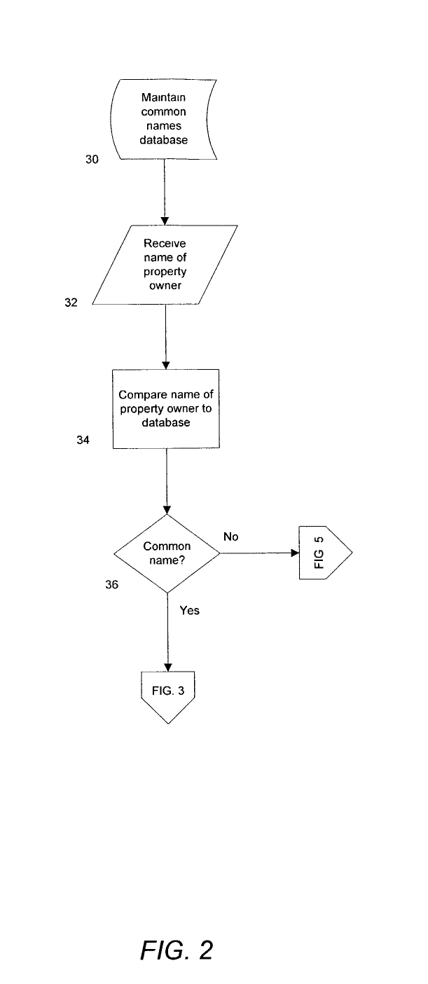

FIGS. 2-5 illustrate flow diagrams of exemplary applications of rules to parcel data in a preferred embodiment. As illustrated in FIG. 2, the specific rules selected may optionally depend on whether the current property owner's name is determined to be a common name. [John—why is does this matter?] Referring to FIG. 2, the system preferably includes a database containing common surnames and given names for plurality of property owners 30. When the system receives 32 the name of a property owner, it compares 34 the property owner's name in the database to determine 36 whether the owner's name is a common name.

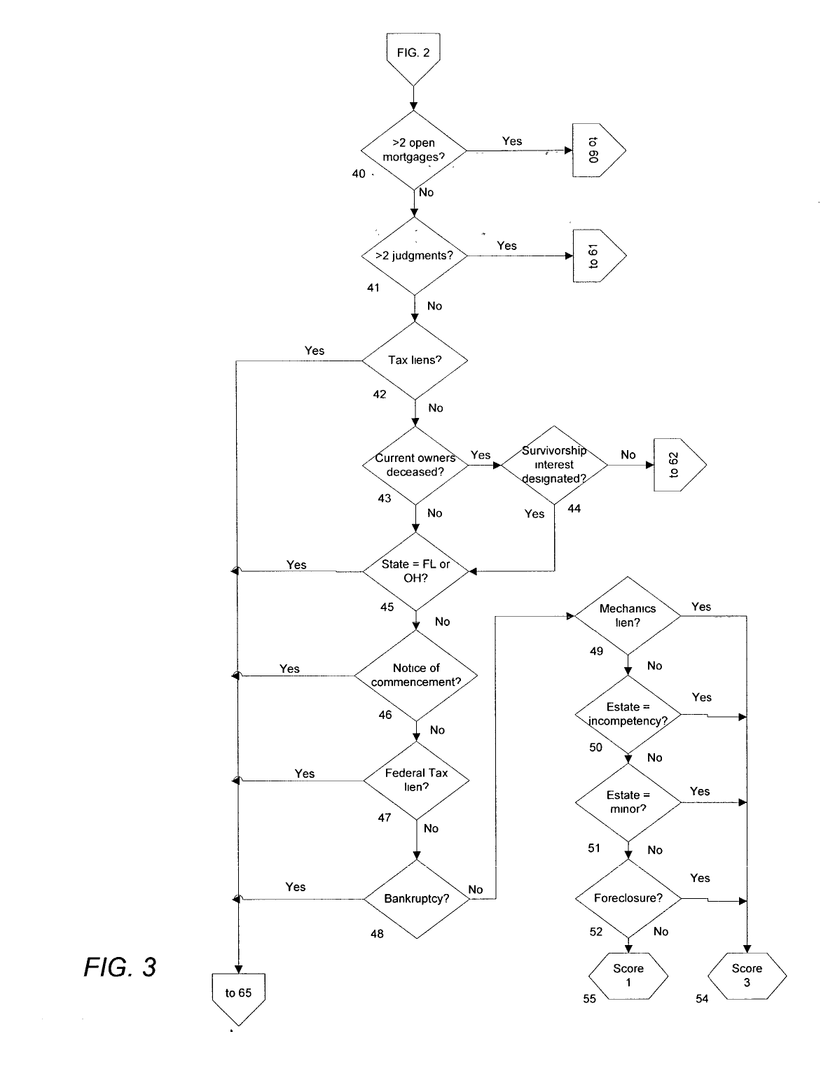

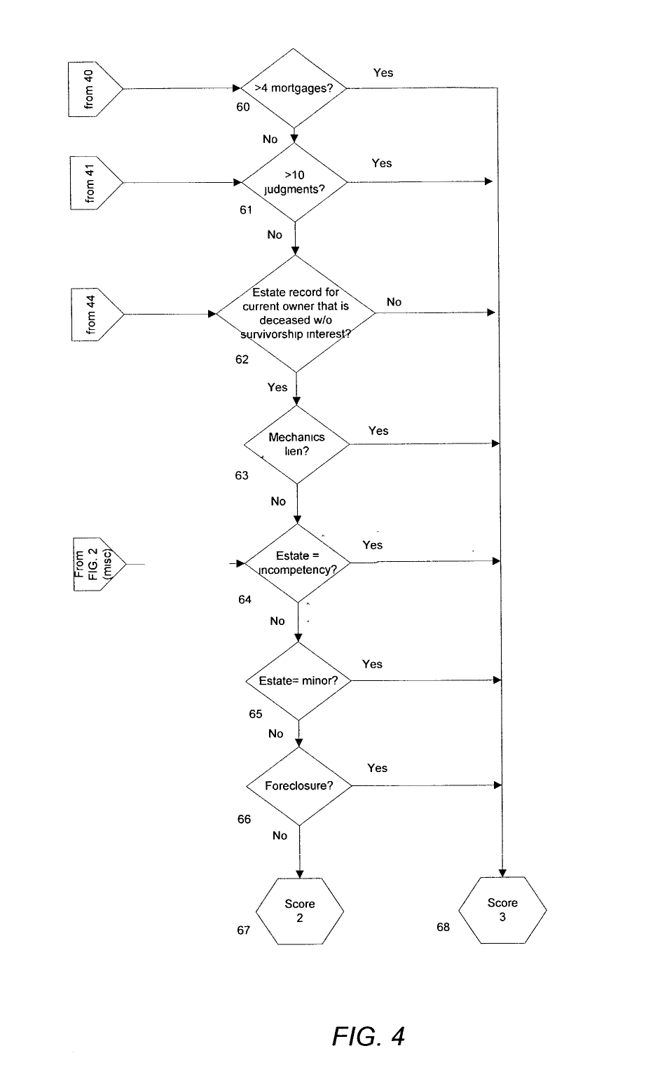

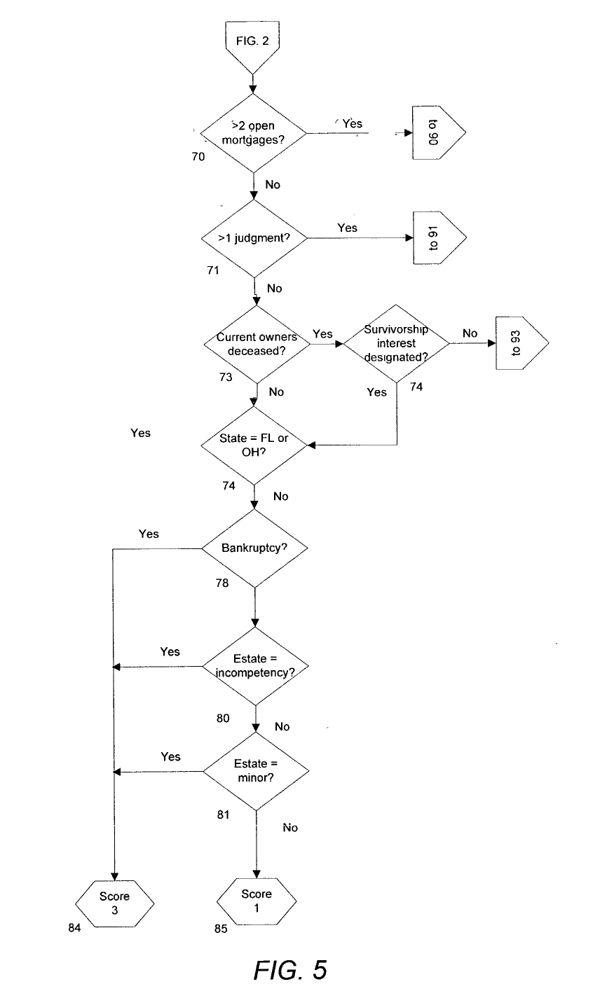

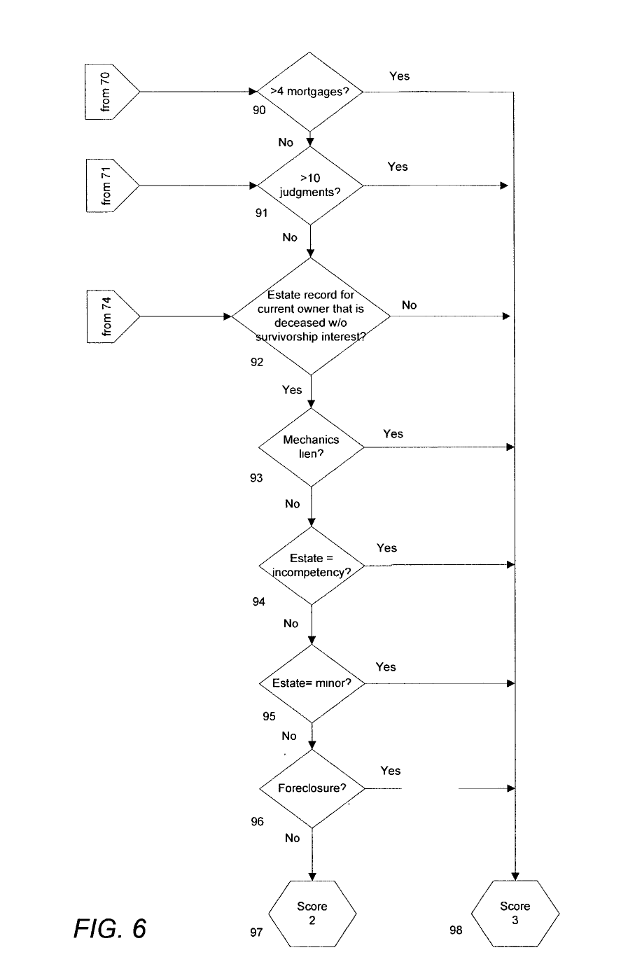

If the name is a common name, then one set of rules (such as that illustrated in FIGS. 3 and 4) may be followed, while another set of rules (such as that illustrated in FIGS. 5 and 6) may be followed if the name is not a common name. This allows the system to optionally and preferably grade or score the title and its exceptions based on whether the name is a common name. For example, a title examination report may identify that a judgment has been filed against a person having the same name as a recorded owner. If the name is a common name (such as John Smith), it is likely that the judgment can be cleared by a mere affidavit from the owner stating that he or she is not the person named in the judgment. If the owner's name is not a common name, then it is likely that the judgment actually applies to the owner, and thus the grade or score of the property would reflect the anticipated difficulty in clearing the judgment.

Preferably, at a minimum the rules always include checking the parcel's chain of title, liens and encumbrances, adverse interest, legal description consistency, and governmental assessment and tax payment records. However, optionally fewer than all of the above may be checked, or the check may stop if one of the items is determined to be unsatisfactory. In addition, other categories of data or information may be checked. For example, the rules may include checking the data to be sure that various items attach to the particular parcel of interest. In addition, the checking of a legal description may be done by reviewing the text of the parcel's legal description and comparing it to a list of predefined keywords. If the legal description contains at least a minimum number of predefined keywords, then the system may conclude that the legal description is a valid legal description.

The rules optionally and preferably generate a score or grade for the parcel, where a higher score reflects problems with the title, while a low score is preferred. Optionally, however, any scoring system may be used. For example, low scores or grades may be indicative of problems. In the example illustrated in FIGS. 3 and 4, the score or grade for a parcel may be increased if there are more than two mortgages recorded against the parcel 40, and the score may be increased even more if more than four mortgages are recorded against the parcel 60. Similarly, the score for a parcel may be increased if there are more than two judgments recorded against the parcel 41, and the score may be increased even more if more than ten judgments are recorded against the parcel 61. (All numbers used in the rules described herein are preferred numbers only, and any number of mortgages, judgments, or other items may optionally be used to adjust the score or grade.) Scores may also be increased in the event that the rules find recorded tax liens 42, deceased owners with no survivorship interest designated 43/44, that the parcel is located in a certain state 45, notices of commencement 46, federal tax liens 47, bankruptcy 48, a mechanics lien 49/63, incompetency in the estate 50/64, a minor in the estate 51/65, foreclosure (especially where the sale of property meets predefined criteria) 66, and/or an estate record for a current owner that is deceased without a survivorship interest 62. Any of the scores may be accumulated, or alternatively and optionally the system may be given a final score if only one of the rules yields a high-scoring result.

Alternatively, in the example illustrated in FIGS. 5 and 6, the score for a parcel may be increased if there are more than two mortgages recorded against the parcel 70, and the score may be increased even more if more than four mortgages are recorded against the parcel 90. Similarly, the score for a parcel may be increased if there are more than two judgments recorded against the parcel 71, and the score may be increased even more if more than ten judgments are recorded against the parcel 91. (As before, all numbers used in the rules list described herein are preferred numbers, and any number of mortgages, judgments, or other items may be used to adjust the score.) Scores may also be increased in the event that the rules find deceased owners with no survivorship interest designated 73/74, that the parcel is located in a certain state 75, bankruptcy 78, a mechanics lien 93, incompetency in the estate 80/94, a minor in the estate 81/95, foreclosure (especially where the sale of property meets predefined criteria) 96, and/or an estate record for a current owner that is deceased without a survivorship interest 92. Again, any of the scores may be accumulated, or alternatively and optionally the system may be given a final score if only one of the rules yields a high-scoring result.

The specific rules that may be used with the present invention may vary from state to state, county to county, and/or municipality to municipality. Also the description above attempts to describe, in general, preferred rules that may be common to most or all jurisdictions. Additional rules, as well as fewer than all of such rules, may be used without departing from the sprit and scope of the present invention. The rules may be applied using a specially-developed rules engine or an existing rules engine such as those available from ILOG, Inc.

The system's memory or a database also preferably includes appropriate requirements and exceptions for title examination. The rules base would select and apply the requirements and exceptions based on the characteristics of the particular title search under review, thus allowing generation of a title commitment without human intervention. However, the system also preferably includes an alarm mechanism to flag or alert a transaction for human review if an issue is beyond the scope of the available rules, if it is too complex, or if there are inconsistencies that cannot be reconciled.

At any time during or after the rule application process, the user may request, and the display will preferably provide, a summary of the rules that failed. For each rule that failed, preferably the system will offer the user the option of entering information, such as updated abstract information, that will correct the failure. The user may also optionally elect to bypass the failure.

If, after the application of the rules to the data elements for a parcel, all rules have passed and/or been bypassed by the user, the system will automatically generate an on-screen, audio, or hard copy commitment report. Preferably, the report will comprise a title insurance commitment consistent with American Land Title Association (ALTA) standards. Preferably, such a commitment would include what is known to those skilled in the art as a Schedule A, which describes the land to be insured and the current owner of record. Preferably, it would also include what is known to those skilled in the art as a Schedule B, which includes a part B-I containing the requirements to be complied with in order to insure the interest (i.e., a mortgage or an ownership or possessory interest), as well as a part B-II which contains exceptions from coverage that would appear in a final title insurance policy unless disposed of to the satisfaction of the insurer or the user. Optionally, the user may direct the system to deliver an electronic copy of the commitment report to a third party, such as an insurer, lender, or applicant.

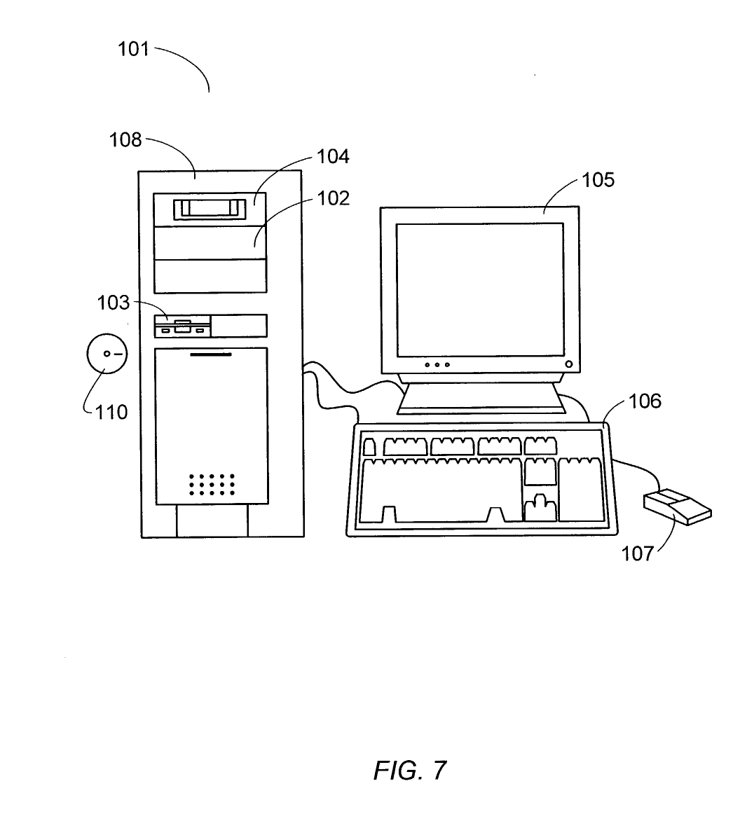

FIG. 7 illustrates a computer of a type suitable for carrying out and/or comprising the system of the invention. Viewed externally in FIG. 7, a computer system designated by reference numeral 101 has a central processing unit located within a housing 108 and memory drives 103 and 104. Disk drives 103 and 104 are merely symbolic of a number of disk drives which might be accommodated by the computer system. Typically these would include a hard disk drive and optionally one or more floppy disk drives such as 103 and/or one or more CD-ROMs, CD-Rs, CD-RWs, ZIP drives, flash memory devices, or other add-on or external memory devices as digital video disk (DVD) devices indicated by slot 104. The number and types of drives typically varies with different computer configurations. Memory drives 103 and 104 are in fact options, and they may be omitted from the computer system used in connection with the processes described herein. Additionally, the computer system utilized for implementing the present invention may be a stand-alone computer having communications capability, a computer connected to a network or able to communicate via a network, a handheld computing device, or any other form of computing device capable of carrying out equivalent operations.

The computer also has or is connected to or delivers signals to a display 105 upon which graphical, video and/or alphanumeric information is displayed. The display may be any device capable of presenting visual images, such as a television screen, a computer monitor, a projection device, a handheld or other microelectronic device having video display capabilities, or even a device such as a headset or helmet worn by the user to present visual images to the user's eyes. The computer may also have or be connected to other means of obtaining signals to be processed. Such means of obtaining these signals may include any device capable of receiving images and image streams, such as video input and graphics cards, digital signal processing units, appropriately configured network connections, or any other microelectronic device having such input capabilities.

An optional keyboard 106 and a directing device 107 such as a remote control, mouse, joystick, touch pad, touch-sensitive screen, track ball, steering wheel, remote control or any other type of pointing or directing device may be provided as input devices to interface with the central processing unit.

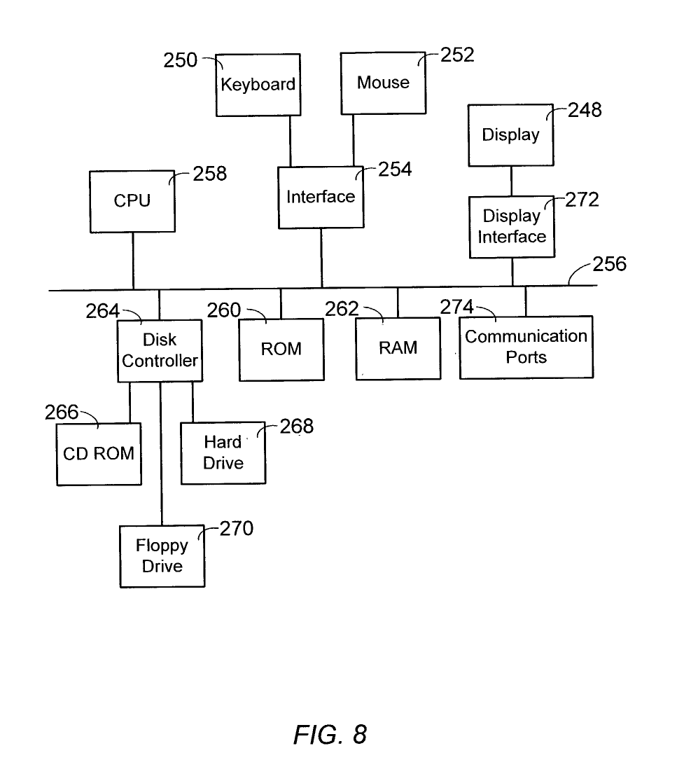

FIG. 8 illustrates a block diagram of the internal hardware of the computer of FIG. 7 A bus 256 serves as the main information highway interconnecting the other components of the computer. CPU 258 is the central processing unit of the system, performing calculations and logic operations required to execute a program. Read only memory (ROM) 260 and random access memory (RAM) 262 constitute the main memory of the computer.

A disk or memory controller 264 interfaces one or more disk or memory drives to the system bus 256. These disk drives may be external or internal floppy disk drives such as 270, external or internal CD-ROM, CD-R, CD-RW, ZIP, flash, or other DVD drives such as 266, or external or internal hard drives 268. As indicated previously, these various disk drives and disk controllers are optional devices.

Program instructions may be stored in the ROM 260 and/or the RAM 262. Optionally, program instructions may be stored on a computer readable carrier such as a floppy disk or a digital disk (107 in FIG. 7) or other recording medium, a communications signal, or a carrier wave.

Returning to FIG. 8, a display interface 272 permits information from the bus 256 to be displayed on the display 248 in audio, graphic or alphanumeric format. Communication with external devices may optionally occur using various communication ports such as 274.

In addition to the standard components of the computer, the computer also includes an interface 254 which allows for data input through the keyboard 250 or other input device and/or the directional or pointing device 252 such as a remote control, pointer, mouse or joystick.

It is to be understood that the invention is not limited in its application to the details of construction and to the arrangements of the components set forth herein the following or illustrated in the drawings. The invention is capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

The invention claimed is:

1. A method of examining title to a real estate parcel, comprising:
maintaining, in a computer-readable memory, a database containing parcel data corresponding to a real estate parcel;
maintaining, in a computer-readable memory, a database containing rules for examining title to the real estate parcel;
applying, via a computing apparatus, one or more of the rules to the parcel data to yield a title examination result for the real estate parcel; and
generating a report comprising the title examination result.

2. The method of claim 1 wherein:
the parcel data comprises a plurality of recorded ownership identifications within a time period; and
the applying step comprises examining the recorded ownership identifications for the parcel to determine whether, upon each transfer of the parcel from one owner to another owner, the recorded owner identification of a buyer for a first transfer matches the recorded owner identification of a seller for a next transfer.

3. The method of claim 2 wherein:
the parcel data also comprises a role that is related to each recorded ownership identification, and
if the applying step determines that the buyer in any first transfer does not match the seller in the next transfer, the applying step further comprises analyzing a role of the buyer for the first transfer and the seller for the next transfer.

4. The method of claim 1 wherein:
the parcel data comprises a plurality of recorded ownership identifications within a time period;
the applying step comprises examining the recorded ownership identifications for the parcel to determine whether, upon any transfer of the parcel from one owner to another owner, a break in chain of title exists for the parcel; and
if the applying step finally determines that a break in chain of title exists, the report comprises a notification that human intervention is required.

5. The method of claim 4 wherein, if the applying step preliminarily determines that an apparent break in chain of title exists, the applying step further comprises determining whether a role of the one owner and/or the other owner supports a cure of the apparent break in chain of title.

6. The method of claim 1 wherein:
the applying step comprises:
examining recorded liens and/or encumbrances for the parcel; and
determining whether one or more liens and/or encumbrances attach to the parcel; and
the title examination result includes a report of all recorded liens and encumbrances that have not been discharged for the parcel.

7. The method of claim 1 wherein:
the applying step comprises:
examining recorded adverse interests for the parcel; and
determining whether one or more adverse interests attach to the parcel; and
the title examination result includes a report of all adverse interests that have not been discharged for the parcel.

8. The method of claim 1 wherein:
the applying step comprises examining recorded governmental assessments and recorded governmental payments relating to the parcel; and
the title examination result includes a report of all recorded governmental assessments that have not been paid for the parcel or an assertion that applicable assessments have been paid.

9. The method of claim 1 wherein:
the parcel data comprises a current legal description for the parcel; and
the applying step comprises comparing the current legal description to previously-recorded legal descriptions for the parcel to assess consistency of the current legal description with the previously-recorded legal descriptions.

10. The method of claim 1 wherein the parcel data comprises one or more owner identifications, a property identification, and an identification of at least one recorded interest.

11. The method of claim 1 wherein:
the title examination result includes a determination of whether at least one adverse interest is recorded for the parcel;
the applying step includes the step of grading the title to the parcel, wherein if the result includes a determination that there is at least one adverse interest the grade reflects the ability to extinguish the at least one adverse interest; and
the report includes a grade corresponding to a result of the grading step.

12. The method of claim 1 wherein the report includes a list of all rules that yielded unsatisfactory results in the applying step.

13. The method of claim 1 wherein:
the method further includes maintaining, in a computer-readable memory, a set of predefined keywords;
the parcel data includes data corresponding to text of a legal description for the parcel;
the method further includes comparing the text of the legal description to the set of predefined keywords to determine if the legal description includes at least a predetermined number of the keywords; and
if the legal description includes at least the predetermined number of the keywords, the method includes determining that the legal description is a valid legal description.

14. A method of examining title to a real estate parcel, comprising:
maintaining a database containing parcel data corresponding to a real estate parcel, the parcel data including a plurality of recorded ownership identifications for the parcel;
maintaining a database containing rules for examining title to the real estate parcel, wherein at least one of the rules comprises examining the recorded ownership identifications for the parcel to determine whether, upon each transfer of the parcel from one owner to another owner, the recorded owner identification of a buyer for a first transfer matches the recorded owner identification of a seller for the next transfer;
applying, via a computing apparatus, the rule for examining recorded ownership identifications to plurality of recorded ownership identifications for the parcel to yield a title examination result for the real estate parcel.

15. A method of verifying a real estate legal description, comprising:
maintaining, in a computer-readable memory, a legal description for a real estate parcel;
maintaining, in a computer-readable memory, a database containing validation keywords;
analyzing, using a computing apparatus, the legal description to determine whether the legal description includes at least a predetermined number of the validation keywords;
if the legal description includes at least the predetermined number of the validation keywords, determining that the legal description is a valid legal description; and
if the legal description does not include at least the predetermined number of the validation keywords, reporting that the legal description is not be a valid legal description.

16. A method of examining title for a real esttae parcel, comprising:
maintaining a database containing parcel data corresponding to a real estate parcel;
maintaining a database containing rules for examining title to the real estate parcel;
applying, via a computing apparatus, one or more of the rules to the parcel data to generate a score corresponding to the title of the parcel.

17. The method of claim 16 further comprising the step of
maintaining, a database containing common surnames and given names for a plurality of property owners; and
comparing, using the computing apparatus, a surname and/or a given name of an owner of a real estate parcel to determine whether the surname and/or given name of the owner corresponds to one of the commonly surnames and/or given names; and
wherein the score further corresponds to the result of the comparing step.

18. A real estate title examination system, comprising:
a computer-readable memory containing a database that includes parcel data corresponding to a real estate parcel;
a computer-readable memory containing a database that includes rules for examining title to the real estate parcel;
a processing device; and
a computer-readable carrier containing program instructions for instructing the processing device to:
apply one or more of the rules to the parcel data to yield title examination result for the real estate parcel; and
generate a report comprising the title examination result.

19. The system of claim 18, wherein:
the parcel data comprises a plurality of recorded ownership identifications within a time period; and
at least one of the rules comprises examining the recorded ownership identifications for the parcel to determine whether, upon each transfer of the parcel from one owner to another owner, the recorded owner identification of a buyer for a first transfer matches the recorded owner identification of a seller for the next transfer.

20. The system of claim 18, wherein:
the parcel data comprises a plurality of recorded ownership identifications within a time period;
at least one of the rules comprises examining the recorded ownership identifications for the parcel to determine whether, upon any transfer of the parcel from one owner to another owner, a break in chain of title exists for the parcel; and
if the application of one or more of the rules to the parcel data finally determines that a break in chain of title exists, the report comprises a notification that human intervention is required.

21. The system of claim 20 wherein, if the application of one or more of the rules to the parcel data preliminarily determines that an apparent break in chain of title exists, the program instructions further instruct the processing device to apply a rule that determine whether a role of the one owner and/or the other owner supports a cure of the apparent break in chain of title.

22. A computer-readable carrier containing program instructions for instructing a computer processing device to:
access a database of parcel data corresponding to a real estate parcel;
access a database of rules for examining title to the real estate parcel;
apply one or more of the rules to the parcel data to yield title examination result for the real estate parcel; and
generate a report comprising the title examination result.

23. The carrier of claim 22 wherein the instructions to apply one or more of the rules to the parcel data comprise instructions to examining recorded ownership identifications for the parcel to determine whether, upon each transfer of the parcel from one owner to another owner, the recorded owner identification of a buyer for a first transfer matches the recorded owner identification of a seller for the next transfer.

24. The carrier of claim 23 wherein the instructions to apply one or more of the rules to the parcel data further comprise instructions to, if the buyer in any first transaction does not match the seller in the next transaction:
preliminarily determine that a break in chain of title exists;
analyze a role of the buyer for the first transfer and a role of the seller for the next transfer to determine whether any of the roles supports a cure in the break in chain of title; and
if none of the roles supports a cure of the break in chain of title, causing the title examination report to indicate the break in chain of title.
